(19) United States
(12) Patent Application Publication
(10) Pub. No.: US 2015/0154187 A1
(43) Pub. Date: Jun. 4, 2015

(54) Method, Apparatus And System For Selecting A User

(71) Applicant: TENCENT TECHNOLOGY (SHENZHEN) COMPANY LIMITED, Shenzhen City (CN)

(72) Inventors: Shangdi YANG, Shenzhen (CN); Yunyu WANG, Shenzhen (CN); Dong CHEN, Shenzhen (CN)

(21) Appl. No.: 14/613,397

(22) Filed: Feb. 4, 2015

Related U.S. Application Data
(63) Continuation of application No. PCT/CN2013/080942, filed on Aug. 7, 2013.

(30) Foreign Application Priority Data
Aug. 8, 2012 (CN) 201210280656.4

(51) Int. Cl. G06F 17/30

(52) U.S. Cl. CPC G06F 17/3007

(57) ABSTRACT

A method for selecting a user which belongs to Internet technology is described. The method includes allocating serial numbers to identities of users participating in the activity in an ascending order of serial numbers. A serial number of a user uniquely identifies the identity of the user. The identity of the user uniquely identifies the user. The method obtains third party data that is accessible by all of the users participating in the activity when a pre-defined time is up. The method obtains specific data through calculations by using a pre-defined rule and the third party data. The method obtains an identity of a user whose serial number is consistent with the specific data, taking the identity as an identity of a selected user, and determines the selected user according to the identity.

### CROSS-REFERENCE TO RELATED APPLICATIONS

This application is a continuation of International Application No. PCT/CN2013/080942 filed on Aug. 7, 2013. This application claims the benefit and priority of Chinese Application No. 201210280656.4, filed Aug. 8, 2012. The entire disclosures of each of the above applications are incorporated herein by reference.

### FIELD

The present disclosure relates to a system for selecting a user.

### BACKGROUND

This section provides background information related to the present disclosure which is not necessarily prior art.

With the continued development of the Internet, Internet activity is continually increasing. Some organizers may hold activities such as a lottery drawing activity, etc. on the Internet. A website on which an activity is organized may record users participating in the activity in a log file and select some of the users randomly from the log file after the activity is ended. Those selected users, also referred to as pre-selected users, are the users selected by the activity.

### SUMMARY

This section provides a general summary of the disclosure, and is not a comprehensive disclosure of its full scope or all of its features.

Various embodiments of the present disclosure can provide a method, an apparatus and a system to increase the transparency of the process of selecting a user and motivate users to actively participate in activities.

Various embodiments of the present disclosure provide a method for selecting a user, which may include:

allocating serial numbers to identities of users participating in an activity in an ascending order of the serial numbers; wherein a serial number of a user uniquely identifies an identity of the user, and the identity of the user uniquely identifies the user;

obtaining third party data that is accessible by each user participating in the activity when a pre-defined time is up; and

obtaining specific data through calculations by using a pre-defined rule and the third party data, obtaining an identity of a user whose serial number is consistent with the specific data from identities of all users participating in the activity, taking the identity obtained as the identity of a pre-selected user, and determining the pre-selected user by using the identity of the pre-selected user.

Various embodiments of the present disclosure also provide an apparatus for selecting a user, which may include:

an allocating module, for allocating a serial number for an identity of each user participating in an activity in an ascending order of serial numbers; wherein the serial number of a user uniquely identifies the identity of the user, and the identity of the user uniquely identifies the user;

an obtaining module, for obtaining third party data that is accessible by each user participating in the activity when a pre-defined time is up;

a calculating module, for obtaining specific data through calculations by using a pre-defined rule and the third party data; and

a determining module, for obtaining from identities of all users participating in the activity an identity of a user whose serial number is consistent with the specific data, taking the identity as the identity of a pre-selected user, and determining the pre-selected user by using the identity of the pre-selected user.

Various embodiments of the present disclosure also provide a system for selecting a user, which may include:

a web server, for obtaining basic information of a user when the user logs in; making an activity server corresponding to the web server work; wherein the basic information may include an identity of the user;

an activity server, for obtaining interaction information generated during participation of the user corresponding to the identity of the user, determining whether the user has completed participation in the activity based on the basic information, and making the serial number allocating server work in response to a determination that the user corresponding to the identity has completed participation in the activity;

a serial number allocating server, for allocating a serial number for an identity of each user participating in an activity in an ascending order of serial numbers after being triggered by the activity server; and

a pre-selected user determining server, for obtaining third party data that is accessible by all users participating in the activity when a pre-defined time is up; obtaining specific data by using a pre-determined rule and the third party data, obtaining an identity of a user whose serial number is consistent with the specific data from identities of all users participating in the activity, taking the identity as an identity of a pre-selected user;

determining the pre-selected user by using the identity and the basic information of the user recorded in the web server.

The various embodiments of the present disclosure allocate serial numbers to identities of users participating in the activity in an ascending order of serial numbers. A serial number of a user uniquely identifies the identity of the user. The identity of the user uniquely identifies the user. Third party data is obtained that is accessible by all of the users participating in the activity when a pre-defined time is up. Specific data is obtained through calculations by using a pre-defined rule and the third party data. An identity of a user whose serial number is consistent with the specific data is obtained, The identity as an identity of a pre-selected user is determined, and the preselected use is determined according to the identity of the pre-selected user.

According to the technical scheme provided by various embodiments of the present disclosure, the pre-selected user may serve as a lucky user selected from the activity. Since the pre-selected user is determined after the identities of users participating in the activity have been allocated with serial numbers and is based on a pre-defined rule and third party data, the selection of the pre-selected user is transparent. Users participating in the activity can verify the result by using the pre-defined rule and the third party data, thus eliminating doubts of users towards the activity. Therefore, users are motivated to participate in such activities, which improve user experience. Thus, the technical scheme of the various embodiments provides a transparent, objective, and fair scheme for selecting a user.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

In order to make the technical scheme of various embodiments of the present disclosure more clear, the following is a brief introduction of the drawings used in description of the various embodiments. The following drawings are merely some of the embodiments, and based on which other drawings can be obtained by those skilled in the art without doing any inventive work.

FIG. 1 is a flowchart illustrating a method for selecting a user in accordance with various embodiments of the present disclosure;

FIG. 2 is a flowchart illustrating a method for selecting a user in accordance with various embodiments of the present disclosure;

FIG. 3 is a diagram illustrating a structure of an apparatus for selecting a user in accordance with various embodiments of the present disclosure;

FIG. 4 is a diagram illustrating a structure of an apparatus for selecting a user in accordance with various embodiments of the present disclosure; and

FIG. 5 is a diagram illustrating a structure of a network for selecting a user in accordance with various embodiments of the present disclosure.

Corresponding reference numerals indicate corresponding parts throughout the several views of the drawings.

### DETAILED DESCRIPTION

Example embodiments will now be described more fully with reference to the accompanying drawings.

The conventional approaches have at least the following deficiencies: the selected users are determined and claimed to be the lucky users wholly based on the selection performed by the website holding the activity. However, the selection process lacks transparency. Users participating in the activity seldom have the chance of knowing how the pre-selected users are selected, which may discourage the users from participating in such activities.

Various embodiments are described in detail with reference to the accompanying drawings to make the objective, technical scheme, and merits of the present disclosure more apparent.

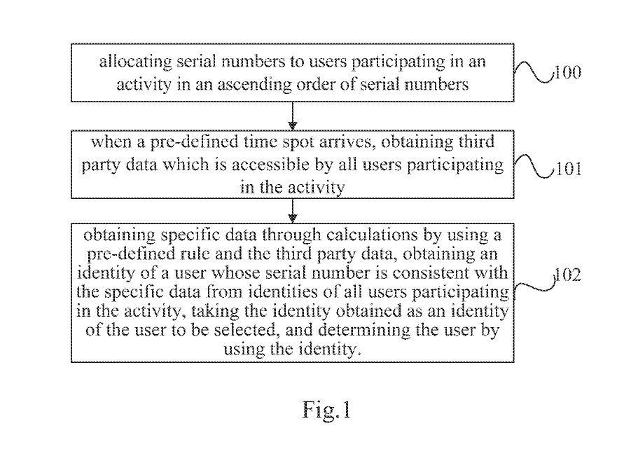

FIG. 1 is a flowchart illustrating a method for selecting a user in accordance with various embodiments of the present disclosure. The method for selecting a user provided by this embodiment is executed by an apparatus for selecting a user. The apparatus may be deployed on the website side that holds an activity. As shown in FIG. 1, the method for selecting a user of this embodiment may include the following.

Block 100: serial numbers are allocated to users participating in an activity in an ascending order of serial numbers.

According to the embodiment, a serial number uniquely identifies an identity of a user, and an identity of a user uniquely identifies the user. The length of the serial number allocated to a user may be defined by the website holding the activity based on an estimation of the total number of users who will participate in the activity. This embodiment allocates serial numbers to users participating in the activity in an ascending order of the serial numbers, thus, the serial number allocated to the last user before the end of the activity indicates the number of users having participated in the activity. For example, serial numbers starting from 1 may be allocated to the users participating in the activity.

The identity of the user in this embodiment may be an account of the user or a user name, or the like. The following description takes a user account as an example to illustrate the whole process of an individual user participating in an activity. The account is manipulated by the user, which is thus regarded to represent the user. In this embodiment, an account may be simply referred to as a user for facilitating description. For example, the procedure in block 100 may be interpreted as allocating serial numbers to accounts of users participating in the activity in an ascending order of the serial numbers, thereby each user is allocated with a serial number.

Block 101: when a pre-defined time is up, third party data which is accessible by all users participating in the activity is obtained. The pre-defined time spot in this embodiment may refer to a deadline for participation in the activity set by the website holding the activity, and this will not be repeated in the following embodiments. For example, the third party data in this embodiment may be the closing value of the NASDAQ index and the closing value of the Dow Jones index on the day when the activity ends, or the turnover of a shopping mall on the day when the activity ends, or the number of guests to a travel site on the day when the activity ends, and so on. The third party data is also accessible by all of the users participating in the activity from an open website or through other means. An apparatus for selecting a user in this embodiment may obtain the third party data from a website, or through other manners, such as the third party data may be obtained by a personnel working for the website holding the activity and inputted into the apparatus for selecting a user via a man-machine inputting interface module. In order to guarantee the open and justness of the activity, the website holding the activity may publish the type of data that is to be used as the third party data.

Block 102: specific data is obtained through calculations by using a pre-defined rule and the third party data, an identity of a user whose serial number is consistent with the specific data is obtained from identities of all of the users participating in the activity as an identity of a user to be selected (also referred to as pre-selected user), and the user is determined by using the identity.

The pre-defined rule in this embodiment is also accessible by all of the users participating in the activity, e.g., may be published by the website holding the activity. The pre-defined rule may be determined according to the third party data and an estimation of the number of users participating in the activity, so that the specific data obtained according to the pre-defined rule and the third party data is within a range from 0 to the estimated number of users participating in the activity. For example, the pre-defined rule may be any combination of logical calculations, e.g., any combination of arithmetical calculations including addition, subtraction, multiplication, division, modulation, modulo, obtaining remainder, extracting a root, and the like. The calculations may also include calculations involving a constant, e.g., adding one, subtracting one, multiplying by 10, or dividing by 12, and the like. In various embodiments, when the result of the calculation generates a decimal fraction, the pre-defined rule may define a rounding up operation or a rounding down operation to process the decimal fraction to generate an integer as the specific data and therefore the user whose serial number is consistent with the specific data is selected.

For example, a website initiating the activity of a lottery drawing which dispatches an iPod touch and a winning number is randomly selected. The manner of selecting the winning number may include: the closing value of the NASDAQ index on Jun. 14×the closing value of the Dow Jones index on Jun. 14×10000 to generate a 12 digit number. Then, the 12 digits in the 12 digit number is arranged in a reversed order and the result is divided by the total number of users who have obtained a lottery ticket (when the serial numbers and the users participating in the activity are in a one-to-one correspondence relation, the maximum serial number equals the total number of users), and the iPod-winning number is defined as the result of adding the remainder obtained and one. If the “lottery ticket number” of a user is consistent with the winning number, the user wins the lottery.

The method for selecting a user provided by various embodiments of the present disclosure allocates serial numbers to identities of users participating in the activity in an ascending order of serial numbers, where a serial number of a user uniquely identifies the identity of the user, and the identity of the user uniquely identifies the user; obtains third party data that is accessible by all of the users participating in the activity when a pre-defined time is up; obtains specific data through calculations by using a pre-defined rule and the third party data, and selects the user whose serial number is consistent with the specific data. According to the technical scheme provided by various embodiments of the present disclosure, the selected user may serve as a lucky user of the activity. Since the user is determined based on a pre-defined rule and third party data after serial numbers have been allocated to the identities of users participating in the activity, the selection of the user is transparent. Users participating in the activity can verify the result by using the pre-defined rule and the third party data, thus eliminating doubts of users towards the activity. Therefore, users are encouraged to participate in such activities, and user experience is improved. Thus, the technical scheme of the embodiment provides a transparent, objective, and fair scheme for selecting a user.

In various embodiments, before serial numbers are allocated to users participating in the activity in block 100 of the technical scheme of the embodiment as shown in FIG. 1, the method may also include determining whether a user has completed participation in the activity.

The following embodiments also take the account of a user as an example of the identity of the user to illustrate the technical scheme of the present disclosure. In various embodiments, an apparatus for selecting a user may first judge whether the account of a user has completed participation in the activity, and allocates a serial number to the account of the user only in response to a determination that the user has completed participation in the activity which shows the user is willing to participate in the activity. Otherwise, in response to a determination that the user corresponding to the account has not completed participation in the activity, the apparatus may perform no action and wait until the user corresponding to the account has completed participation in the activity. The participation in the activity in this embodiment may include filling out certain information and the like, is the same as that in the conventional art, and thus, will not be described further herein.

In various embodiments, it is required that a user participating in the activity should be a logon user, therefore, before judging whether the user has completed participation in the activity, the method may also include obtaining basic information of the user when the user performs login. The basic information may include the identity of the user.

The basic information in this embodiment may also include an email address or a mobile phone number of the user and the like, such that the user can be informed when the user is selected. Alternatively, the basic information may only include information of the identity of the user, such as user nickname, user name or account name, and the like. In this case, the user has to check whether he/she is selected by him/herself, and the selected user has to contact the website holding the activity to claim the prize.

In various embodiments, after the basic information of the user is obtained and before the serial numbers are allocated to users participating in the activity, the method may also include recording the basic information of the user in a log file. After the serial numbers are allocated to identities of the users in an ascending order of serial numbers, the serial number allocated to a user may be recorded in the log file.

Thus, the apparatus for selecting a user may judge whether an identity of a user has been allocated with a serial number by checking information on each user recorded in the log file. In case an identity of a user has not been allocated with a serial number due to certain reasons such as network failure or network jitter and the like, the identity of the user may be allocated with a serial number in an ascending order of serial numbers. Alternatively, when an activity server is to allocate a serial number to an identity of a user by remotely calling the user but the remote calling of the user has failed, information of the failure may also be recorded in the log file. The apparatus for selecting a user may check failure information in the log file at intervals to recover the failure to allocate a serial number to the identity of the user.

According to the technical scheme provided by various embodiments, the selected user may serve as a lucky user selected by the activity. Since the selected user is determined based on a pre-defined rule and third party data after serial numbers have been allocated to the identities of users participating in the activity, the selection of the selected user is transparent. Users participating in the activity can verify the result by using the pre-defined rule and the third party data, thus eliminating doubts of users towards the activity. Therefore, users are encouraged to participate in such activities, and user experience is improved. Thus, the technical scheme of the embodiment provides a transparent, objective, and fair scheme for selecting a user.

In the various embodiments, the technical scheme is illustrated by taking an apparatus for selecting a user executing the procedures as an example. However, in practice, a website having a large number of users participating in an activity may adopt a distributed system to implement the technical scheme. The entity that carries out the procedures may be a distributed system for selecting a user. The distributed system may include a Web server, an activity server, a serial number allocating server, and a user selecting server. The Web server is for processing login requests of users and may obtain basic information of the users. The activity server is for detecting whether a user has completed participation in the activity. Each Web server may serve one or multiple registered users. When there are mass amounts of users, the distributed system may include multiple Web servers and multiple activity servers. In this architecture, there may be one serial number allocating server and one user selecting server. The serial number allocating server is for executing the procedures in block 100 of the various embodiments, and the user selecting server is for executing the procedures in block 101 and block 102 of the above embodiments. The distributed system for selecting a user may be deployed at the website holding the activity. The process of the distributed system for selecting a user is described in the following embodiments.

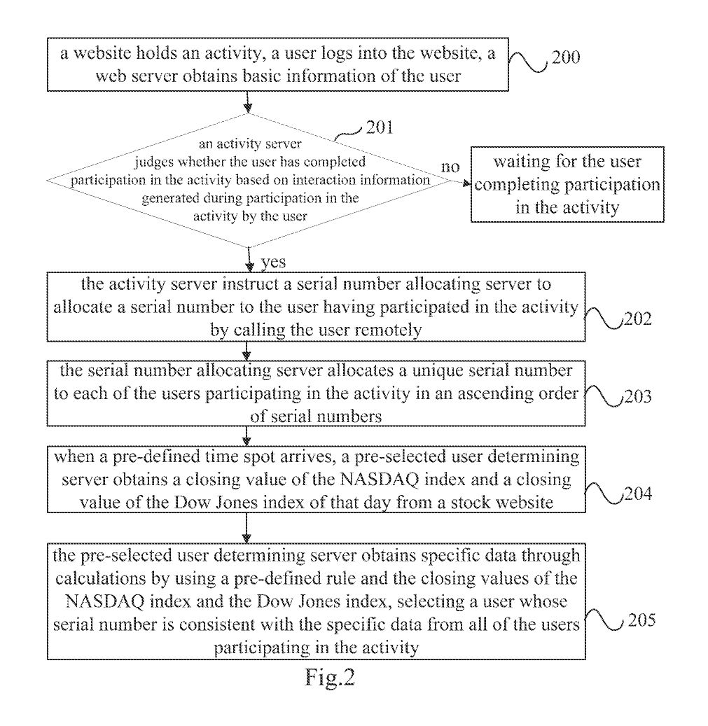

FIG. 2 is a flowchart illustrating a method for selecting a user in accordance with various embodiments of the present disclosure. In the example as shown in FIG. 2, the method for selecting a user of this embodiment is implemented by a distributed system. The distributed system may include multiple Web servers, multiple activity servers, a serial number allocating server, and a user selecting server. The number of the Web servers and the activity servers are not limited, and a web server may serve one or multiple users. The method for selecting a user of this embodiment may include the following procedures.

Block 200: a website initiates an activity, a user logs into the website, and a web server obtains basic information of the user.

In various embodiments, the activity initiated by the website may be a “seckilling” promotion, a flash sale, or a limited sale, and so on. A user logging into the website may participate in the activity. The user logging onto the website may be a registered user or a non-registered user, and this can be defined by the website. In practice, a website is generally regulated so that only registered users can participate in the activity so as to obtain basic information of the users.

In this embodiment, multiple users logging in to the website may request to participate in the activity via different web servers. A user may participate in an activity in various manners, such as by clicking on a button or by sending L messages. L is a pre-defined value, and can be any value, which is not limited by this embodiment. After receiving a request from a user for participating in the activity, a web server may send the request of the user to an activity server. The activity server obtains interaction information generated by the user during participation in the activity, judges whether the user has completed participation in the activity, and stores information of the user who has completed participation in the activity.

Block 201: the activity server obtains interaction information generated by the user during participation in the activity, judges whether the user has completed participation in the activity based on the interaction information, and performs the procedure in block 202 in response to a determination that the user has completed participation in the activity, or waits for the user to complete participation in the activity in response to a determination that the user has not completed participation in the activity.

In various embodiments, the activity server is configured for performing logical calculations, judges whether a user has participated in the activity, obtains basic information of the user in response to a determination that the user has participated in the activity, and sends the basic information of the user to the serial number allocating server by a remote calling process, i.e., storing the basic information of the user into a queue in the serial number allocating server. In an embodiment, the activity server has error tolerance capabilities, i.e., judges whether remote calling of a user is successful, and generates and stores failure information in case of a failure. The process of the user participating in the activity is reflected by the identity of the user participating in the activity.

The interaction information generated during participation of the user in the activity obtained by the activity server is decided by the manner of the user participating in the activity. For example, when the user participates in the activity by clicking on a button, the interaction information obtained by the activity server is linkage information corresponding to the button; when the user participates in the activity by sending L messages, the interaction information obtained by the activity server is the L messages.

The activity server may judge whether the user has completed participation in the activity based on the interaction information, e.g., determining the user has completed participation in the activity after receiving the linkage information corresponding to the button or after receiving the L messages sent by the user participating in the activity; otherwise, determining that the user has not completed participation in the activity.

Block 202: the activity server may instruct the serial number allocating server to allocate a serial number to the user participating in the activity by calling the user.

In various embodiments, the activity server may put the basic information of the called user into a queue of users waiting for serial number allocation and wait for the serial number allocating server to allocate a serial number to the user. When the system includes multiple activity servers, each activity server may collect basic information of users waiting to be allocated with serial numbers in the activity server and send the basic information to the serial number allocating server. The basic information gathers in the serial number allocating server and the serial number allocating server allocates serial numbers to the users in a certain order. The activity server instructs the serial number allocating server to allocate serial numbers to users having participated in the activity by calling users. In various embodiments, the activity server may instruct the serial number allocating server to allocate serial numbers to identities of users having participated in the activity by calling users to implement allocating serial numbers to users having participated in the activity.

Block 203: the serial number allocating server allocates a unique serial number to each user participating in the activity in an ascending order of serial numbers.

The ascending manner may be pre-defined. For example, if the increment of serial numbers generated is 1, when there are N users, the serial numbers generated for the N users may be 1, 2, 3, . . . N; if the increment of serial numbers generated is M, when there are N users, the serial numbers generated for the N users may be 1, 1+M, 1+2M, 1+3M, . . . 1+(N-1)*M.

Optionally, the activity server may store basic information of a user participating in the activity into a log file, and record a serial number of the user after the user has been allocated with a serial number. The serial number allocating server may periodically check the log file, judge whether a user has been allocated with a serial number, and allocate a serial number to a user in time when the user in the record has not been allocated with a serial number due to network system failure, network jitter, or other reasons.

Alternatively, the activity server may have error tolerance capabilities, i.e., judges whether remote calling of a user is successful, and generates and stores failure information in case of a failure. The serial number allocating server may periodically analyze failure information stored by the activity server, automatically recover the failure information, re-allocate serial numbers to solve the problem of missing data resulting from failed remote calling of a user by the activity server due to a failure in the serial number allocating server or due to network jitter.

In various embodiments, the log file may be stored at any location accessible by the activity server and the serial number allocating server.

Various embodiments also provide a remote log server. When failure information is generated, the activity server sends the failure information to the remote log server where the failure information is stored. The serial number allocating server may periodically analyze failure information stored in the remote log server, automatically recover the failure information stored there, and re-allocate serial numbers to solve the problem of missing data due to failure of remotely calling a user by the activity server caused by failure of the serial number allocating server or network jitter.

The serial number allocating server may allocate a unique serial number for each user participating in the activity in an ascending order of serial numbers. In various embodiments, the serial number allocating server may allocate a unique serial number for the account or the identity of each user participating in the activity in an ascending order of serial numbers to allocate a unique serial number for each user participating in the activity in an ascending order of serial numbers.

Block 204: when a pre-defined time is up, a user selecting server obtains the closing value of the NASDAQ index and the closing value of the Dow Jones index on that day from a certain stock website.

This embodiment takes the closing value of the NASDAQ index and the closing value of the Dow Jones index of the day from a certain stock website as an example of the third party data since the closing values of the NASDAQ index and the Dow Jones index of the day is accessible by all users participating in the activity.

Block 205: the user selecting server may obtain specific data by calculation using the obtained values of NASDAQ index and Dow Jones index according to a pre-determined rule, and selecting a user whose serial number is consistent with the specific data among all of the users participating in the activity as the selected user.

In various embodiments, block 205 may include: the user selecting server obtains an identity of a user whose serial number is consistent with the specific data from identities of all of the users participating in the activity as the identity of the selected user, determining the selected user according to the identity of the selected user to implement selecting a user whose serial number is consistent with the specific data from all users participating in the activity as the selected user.

In various embodiments, the pre-defined rule may be: the value of the NASDAQ index×the value of the Dow Jones index×10000=a 12-digit number; then, the digits in the 12-digit number are arranged in a reversed order to generate a new 12-digit number which is then divided by the total number of users participating in the activity. A constant number K is then added to the result of the division to obtain the specific data. The constant number K may be a positive integer, a negative integer, or 0. The pre-defined rule should be designed to make sure that the specific data obtained is within the range of 0 to the maximum serial number and equals a serial number of a user according to the rule of allocating serial numbers. The maximum serial number is the serial number allocated to the last user that participated in the activity.

Other pre-defined rules may also be adopted in blocks 204 and 205, and the detailed implementation manner is similar to the above embodiment shown in FIG. 1, thus, will not be described further.

According to the technical scheme provided by various embodiments, the selected user may serve as a lucky user selected by the activity. Since the selected user is determined based on a pre-defined rule and third party data, the selection of the user is transparent. Users participating in the activity can verify the result by using the pre-defined rule and the third party data, thus eliminating doubts of users towards the activity. Therefore, users are encouraged to participate in such activities, and user experience is improved. Thus, the technical scheme of the embodiment provides a transparent, objective, and fair scheme for selecting a user.

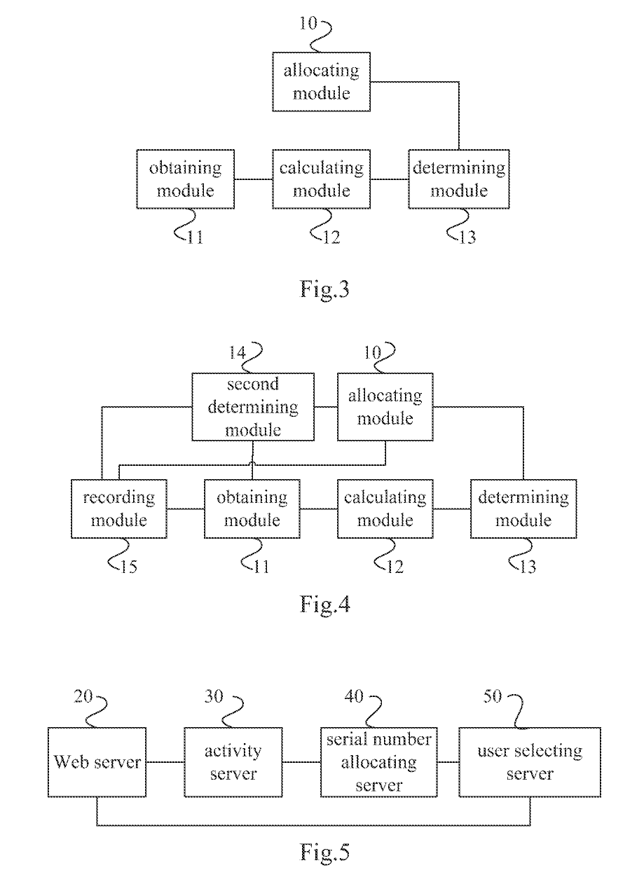

FIG. 3 is a diagram illustrating a structure of an apparatus for selecting a user in accordance with various embodiments of the present disclosure. As shown in FIG. 3, the method for selecting a user may include: an allocating module 10, an obtaining module 11, a calculating module 12, and a determining module 13.

The allocating module is configured for allocating serial numbers to identities of users participating in an activity in an ascending order of serial numbers. The serial number of a user uniquely identifies the identity of the user, and the identity of the user uniquely identifies the user. The obtaining module 11 is configured for obtaining third party data which is accessible by all of the users participating in the activity when a pre-defined time is up. The calculating module 12 is connected to the obtaining module 11, and is configured for obtaining specific data through calculations by using the third party data obtained by the obtaining module 11 and a pre-defined rule. The determining module 13 is connected with the allocating module 10 and the calculating module 12, is configured for obtaining an identity of a user whose serial number is consistent with the specific data obtained by the calculating module 12 from identities of all of the users participating in the activity whose serial numbers are allocated by the allocating module 10, and taking the identity of the user as an identity of a selected user, and determining the selected user based on the identity of the selected user.

The identity of a user may be a name of the user or an account of the user, and the like.

The apparatus for selecting a user implements obtaining a selected user by using the above modules in the same manner of the above method embodiment. Details of the implementation can be found in the above description in connection with the above method, and will not be described further herein.

The apparatus for selecting a user provided by various embodiments allocates serial numbers to identities of users participating in the activity in an ascending order of serial numbers, where a serial number of a user uniquely identifies the identity of the user, and the identity of the user uniquely identifies the user; obtains third party data that is accessible by all of the users participating in the activity when a pre-defined time is up; obtains specific data through calculations by using a pre-defined rule and the third party data, obtains an identity of a user whose serial number is consistent with the specific data, takes the identity as an identity of a selected user, and determines the selected user according to the identity of the selected user. According to the technical scheme provided by various embodiments of the present disclosure, the selected user may serve as a lucky user selected by the activity. Since the selected user is determined based on a pre-defined rule and third party data after serial numbers have been allocated to the identities of users participating in the activity, the selection of the selected user is transparent, users participating in the activity can verify the result by using the pre-defined rule and the third party data, thus eliminating doubts of users towards the activity. Therefore, users are encouraged to participate in such activities, and user experience is improved. Thus, the technical scheme of the embodiment provides a transparent, objective, and fair scheme for selecting a user.

FIG. 4 is a diagram illustrating a structure of an apparatus for selecting a user in accordance with various embodiments of the present disclosure. As shown in FIG. 4, the apparatus for selecting a user of this embodiment is based on the technical scheme as shown in FIG. 3, and may further include the following technical scheme.

The apparatus of this embodiment may also include a determining module 14. The obtaining module 11 is also configured for obtaining interaction information generated during the user participating in the activity. The determining module 14 is connected with the obtaining module 11 and is configured for determining the user corresponding to an identity of the user has completed participation in the activity based on the interaction information obtained by the obtaining module 11 before the allocating module 11 allocates serial numbers for the users participating in the activity. The allocating module 10 is also connected with the determining module 14, and is configured for allocating serial numbers to the users participating in the activity in an ascending order of serial numbers after the determining module 14 has determined that the user has completed participation in the activity.

In various embodiments, the obtaining module 11 of the apparatus as shown in FIG. 4 may also be configured for obtaining basic information of a user when the user performs login before the determining module 14 determines the user has completed participation in the activity. The basic information of the user may include an identity of the user. The determining module 14 is configured for determining that the user corresponding to the identity of the user has completed participation in the activity after the obtaining module 11 obtained the basic information of the user.

In various embodiments, the apparatus as shown in FIG. 4 may also include a recording module 15. The recording module 15 is connected with the obtaining module 11, is configured for recording the basic information of the user in a log file after the obtaining module 11 has obtained the basic information of the user and before the allocating module 10 allocates serial numbers to users participating in the activity in an ascending order of serial number. The recording module 15 is also connected with the allocating module, and is configured for recording serial numbers allocated by the allocating module 10 to the users after the allocating module 10 has allocated the serial numbers to the users participating in the activity in an ascending order of serial numbers.

In various embodiments, the determining module 14 of the apparatus may optionally be configured for determining an identity of a user recorded in the log file has not been allocated with a serial number after the recording module 15 has recorded the basic information of the user in the log file and before the allocating module 10 allocates serial numbers to the users participating in the activity. The determining module 14 is connected with the recording module 15, and is configured for determining an identity of a user participating in the activity recorded in the log file by the recording module has not been allocated with a serial number, and instructing the allocating module 10 to allocate a serial number for the identity of the user.

The manner of the above modules implementing the process of obtaining the selected user is the same with the above method embodiments, and details can be found in the above description in connection with the methods, and thus, will not be elaborated further herein.

The apparatus of the embodiment adopts the above technical scheme to determine a selected user and take the selected user as a lucky user selected by the activity. Since the selected user is determined based on a pre-defined rule and third party data after serial numbers have been allocated to the identities of users participating in the activity, the selection of the user is transparent. Users participating in the activity can verify the result by using the pre-defined rule and the third party data, thus eliminating doubts of users towards the activity. Therefore, users are encouraged to participate in such activities and user experience is improved. Thus, the technical scheme of the embodiment provides a transparent, objective, and fair scheme for selecting a user.

FIG. 5 is a diagram illustrating a structure of a distributed system for selecting a user in accordance with various embodiments of the present disclosure. The distributed system for selecting a user of this embodiment may include at least one Web server 20, at least one activity server 30, a serial number allocating server 40, and a user selecting server 50. As shown in FIG. 5, the following description takes a distributed system including a Web server 20 and an activity server 30 as an example to illustrate the technical scheme of the present disclosure. In practice, multiple Web servers 20 and multiple activity servers 30 may be deployed based on the number of users participating in an activity. Each Web server 20 is able to communicate with an activity server 30 corresponding to the Web server 20. The activity server 30 is configured for determining whether a user having logged on obtained by the Web server 20 has participated in the activity. In various embodiments, the Web server may obtain basic information of a user having logged in. The basic information of the user may include an identity of the user. When there are multiple Web servers 20 and multiple activity servers 30, the multiple activity server 30 all communicate with a serial number allocating server 40.

The Web server 20 is configured for obtaining the basic information of a user when the user performs login, and instructing the activity server 30 corresponding to the Web server 20 to work. The activity server 30 is configured for obtaining interaction information generated during the user corresponding to the identity of the user participating in the activity after being instructed by the Web server 20, judges whether the user has completed participation in the activity based on the interaction information, and instructing the serial number allocating server 40 to work in response to a determination that the user corresponding to the identity of the user has completed participation in the activity. Details can be found in the above description in connection with FIG. 2. The serial number allocating server 40 is configured for allocating serial numbers to users participating in the activity in an ascending order of serial numbers after being instructed by the activity server 30. The user selecting server 50 is configured for obtaining third party data which is accessible by all of the users participating in the activity when a pre-defined time is up, obtaining specific data by using a pre-defined rule and the third party data, obtaining an identity of a user whose serial number allocated by the serial number allocating server 40 is consistent with the specific data from identities of all of the users participating in the activity, taking the identity obtained as an identity of a selected user, and determining the selected user by using the identity of the selected user and the basic information of the user recorded in the Web server 20. The PR-user selecting server 50 is connected with the Web server 20, is configured for obtaining the basic information of the user from the Web server 20.

The distributed system for selecting a user implements obtaining a selected user by using the above servers in the same manner of the above method embodiment. The manners implemented by the distributed system at least include the following:

a method (i.e., manner) for selecting a user,

implemented at various servers 20, 30, 40, 50 having one or more processors and memory storing instructions directing the processors to perform acts comprising:

allocating a serial number to an identity of each user participating in an activity in an ascending order of serial numbers;

obtaining third party data that is accessible by each user participating the activity when a pre-defined time is up; and

obtaining specific data through calculations by using a pre-set rule and the third party data, selecting a user whose serial number is consistent with the specific data from identities of all users participating in the activity.

The method as above further comprising:

obtaining interaction information generated during participation in the activity by a user corresponding to an identity and determining the user corresponding to the identity has completed participation in the activity according to the interaction information before allocating a serial number to the user; or

further comprising:

obtaining basic information of the user when the user logs in before determining the user corresponding to the identity has completed participation in the activity; wherein the basic information of the user includes the identity of the user.

The method as above, further comprising: after obtaining basic information of the user when the user logs in and before allocating a serial number for the identity of each user participating in the activity,

recording the basic information of the user in a log file after obtaining the basic information of the user when the user logs in and before allocating a serial number to the identity of the user;

after allocating the serial number to the identity of the user participating in the activity, recording the serial number of the user in the log file.

The method as above, further comprising: after obtaining basic information of the user when the user logs in and before allocating a serial number for the identity of each user participating in the activity,

determining that the identity of the user recorded in the log file has not been allocated with a serial number after obtaining the basic information of the user when the user logs in and before allocating the serial number to the identity of each user participating in the activity.

Details of the implementation can be found in the above description in connection with the above method, and will not be described further herein.

The distributed system of the embodiment adopts the above servers to determine a selected user by using a pre-defined rule and third party data after serial numbers are allocated to identities of users participating in the activity and take the selected user as a lucky user selected by the activity. The selection of the selected user is transparent. Users participating in the activity can verify the result by using the pre-defined rule and the third party data, thus eliminating doubts of users towards the activity. Therefore, users are encouraged to participate in such activities, and user experience is improved. Thus, the technical scheme of the embodiment provides a transparent, objective, and fair scheme for selecting a user.

In various embodiments, the activity server 30 is based on the embodiment shown in FIG. 5, and may further be configured for recording the basic information of the user in a log file after being triggered by the Web server 20 and before judging whether the user corresponding to the identity has completed participation in the activity.

The serial number allocating server 40 may further be configured for triggering the activity server to record the serial number of the user in the log file after allocating the serial numbers for the users participating in the activity in an ascending order of serial numbers.

In various embodiments, based on the embodiment shown in FIG. 5, the activity server 30 may further be configured for judging whether a user recorded in the log file has been allocated with a serial number and instructing the serial number allocating server 40 to allocate a serial number for a user participating in the activity in response to a determination that the identity of the user recorded in the log file has not been allocated with a serial number.

In various embodiments, based on the embodiment shown in FIG. 5, the activity server 30 may further be configured for triggering the serial number allocating server 40 by using a manner of calling a user remotely.

The distributed system for selecting a user implements obtaining a selected user by using the above servers in the same manner of the above method embodiment. Details of the implementation can be found in the above description in connection with the above method, and will not be described further herein.

The distributed system of the embodiment adopts the above servers to determine a selected user by using a pre-defined rule and third party data after serial numbers are allocated to identities of users participating in the activity and take the selected user as a lucky user selected by the activity. The selection of the user is transparent. Users participating in the activity can verify the result by using the pre-defined rule and the third party data, thus eliminating doubts of users towards the activity. Therefore, users are encouraged to participate in such activities, and user experience is improved. Thus, the technical scheme of the embodiment provides a transparent, objective, and fair scheme for selecting a user.

The above description of the apparatus for selecting a user takes the above modules as an example. In practice, the functions may be re-divided to be implemented by different modules, i.e., the apparatus may have a different inner structure composed of different modules to implement all or some of the above functions. In addition, the above methods for selecting a user provided by the embodiments belong to the same conceptive idea. Details have been described in the above, and will not be repeated herein.

The index numbers of the embodiments are merely for facilitating description, and should not be interpreted to be representative for the preference order of the embodiments.

Those skilled in the art can understand that some or all of the steps of the methods provided by the embodiments may be implemented by hardware controlled by software. The software may be stored in a computer-readable storage medium.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

A machine-readable storage medium is also provided, which is to store instructions to cause a machine to execute a control method as disclosed herein. Specifically, a system or apparatus having a storage medium which stores machine-readable program codes for implementing functions of any of the above examples and which may make the system or the apparatus (or CPU or MPU) read and execute the program codes stored in the storage medium. In this situation, the program codes read from the storage medium may implement any one of the above examples, thus, the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

The scope of the claims should not be limited by the embodiments set forth in the examples, but should be given the broadest interpretation consistent with the description as a whole.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for selecting a user,
implemented at various servers having one or more processors and memory storing instructions directing the processors to perform acts comprising:
allocating a serial number to an identity of each user participating in an activity in an ascending order of serial numbers;
obtaining third party data that is accessible by each user participating the activity when a pre-defined time is up;
obtaining specific data through calculations by using a pre-set rule and the third party data, selecting a user whose serial number is consistent with the specific data from identities of all users participating in the activity.

2. The method of claim 1, further comprising:
obtaining interaction information generated during participation in the activity by a user corresponding to an identity, and determining the user corresponding to the identity has completed participation in the activity according to the interaction information before allocating a serial number to the user.

3. The method of claim 1, further comprising:
obtaining basic information of the user when the user logs in before determining the user corresponding to the identity has completed participation in the activity; wherein the basic information of the user includes the identity of the user.

4. The method of claim 3, further comprising: after obtaining basic information of the user when the user logs in and before allocating a serial number for the identity of each user participating in the activity,
recording the basic information of the user in a log file after obtaining the basic information of the user when the user logs in and before allocating a serial number to the identity of the user;
after allocating the serial number to the identity of the user participating in the activity,
recording the serial number of the user in the log file.

5. The method of claim 4, further comprising: after obtaining basic information of the user when the user logs in and before allocating a serial number for the identity of each user participating in the activity,
determining that the identity of the user recorded in the log file has not been allocated with a serial number after obtaining the basic information of the user when the user logs in and before allocating the serial number to the identity of each user participating in the activity.

6. An apparatus for selecting a user, comprising:
an allocating module, configured for allocating a serial number for an identity of each user participating in an activity in an ascending order of serial numbers;
an obtaining module, configured for obtaining third party data that is accessible by each user participating in the activity when a pre-defined time is up;
a calculating module, configured for obtaining specific data through calculations by using a pre-defined rule and the third party data;
a determining module, for obtaining from identities of all users participating in the activity an identity of a user whose serial number is consistent with the specific data, and determining the selected user by using the identity obtained.

7. The apparatus of claim 6, wherein
the obtaining module is further configured for obtaining interaction information generated during the participation in the activity by the user corresponding to the identity;
the determining module is further configured for determining the user has completed participation in the activity based on the interaction information obtained by the obtaining module before the allocating module allocates the serial number to the identity of the user.

8. The apparatus of claim 6, wherein
the obtaining module is further configured for obtaining basic information of the user when the user logs in before the determining module determines the user has completed participation in the activity; wherein the basic information comprises the identity of the user.

9. The apparatus of claim 8, further comprising:
a recording module, configured for recording the basic information of the user in a log file after the obtaining module has obtained the basic information and before the allocating module allocates the serial number to the identity of the user;
recording the serial number of the user in the log file after the allocating module has allocated the serial number to the identity of the user.

10. The apparatus of claim 9, wherein
the determining module is further configured for determining that the identity of the user recorded in the log file has not been allocated with a serial number after the recording module has recorded the basic information of the user and before the allocating module has allocated the serial number to the user participating in the activity.

11. A system for selecting a user, comprising: at least one Web server, at least one activity server, a serial number allocating server and a user selecting server; wherein
the web server is configured for obtaining basic information of a user when the user logs in; making an activity server corresponding to the web server work; wherein the basic information comprises an identity of the user;
an activity server is configured for obtaining interaction information generated during participation in the activity by the user corresponding to the identity of the user, determining whether the user has completed participation in the activity based on the basic information, and making the serial number allocating server work in response to a determination that the user corresponding to the identity has completed participation in the activity;
the serial number allocating server is configured for allocating a serial number for an identity of each user participating in the activity in an ascending order of serial numbers after being triggered by the activity server; and
the user selecting server is configured for obtaining third party data that is accessible by all users participating in the activity when a pre-defined time is up; obtaining specific data by using a pre-determined rule and the third party data, obtaining an identity of a user whose serial number is consistent with the specific data from identities of all of the users participating in the; determining the selected user by using the identity and the basic information of the user recorded in the web server.

12. The system of claim 11, wherein:
the activity server is further configured for recording the basic information of the user in a log file after being triggered by the web server and before judging whether the user corresponding to the identity has completed participation in the activity;
the serial number allocating server is further configured for triggering the activity server to record the serial number of the user in the log file after allocating the serial numbers to the identity of the user in an ascending order of serial numbers.

13. The system of claim 12, wherein:
the activity server is further configured for judging whether an identity of a user recorded in the log file has been allocated with a serial number, and instructing the serial number allocating server to allocate a serial number to the identity of the user participating in the activity after determining the identity of the user recorded in the log file has not been allocated with a serial number.

14. The system of claim 12, wherein the activity server is configured for making the serial number allocating server work by calling a user remotely.
